(19) United States
(12) Patent Application Publication
(10) Pub. No.: US 2018/0129529 A1
(43) Pub. Date: May 10, 2018

(54) RESOURCE-DEPENDENT AUTOMATED JOB SUSPENSION/RESUMPTION

(71) Applicant: International Business Machines Corporation, Armonk, NY (US)

(72) Inventors: Ronald D. Boenig, II, Golden, CO (US); Sri Hari Kolusu, Tucson, AZ (US); David C. Reed, Tucson, AZ (US); Michael R. Scott, Ocean View, HI (US); Samuel R. Smith, Vail, AZ (US)

(73) Assignee: International Business Machines Corporation, Armonk, NY (US)

(21) Appl. No.: 15/344,086

(22) Filed: Nov. 4, 2016

(51) Int. Cl. G06F 9/48; G06F 9/50; G06F 9/46; G06F 11/30; G06F 11/34

(52) U.S. Cl. CPC G06F 9/485; G06F 9/50; G06F 11/3442; G06F 11/3006; G06F 11/3409; G06F 9/461

(57) ABSTRACT

A method for executing a job is disclosed. In one embodiment, such a method includes initiating a job using an initial level of computing resources (e.g., memory resources, CPU resources, and storage resources, etc.). The method suspends the job when available computing resources fall below a first threshold. When suspending the job, the method saves information to enable the job to be resumed at the point where it was suspended. The method then monitors the available computing resources to determine when the available computing resources rise above a second threshold. The second threshold may, in certain embodiments, be the same as the first threshold. The method resumes the job using a reduced level of computing resources when the available computing resources rise above the second threshold. A corresponding system and computer program product are also disclosed.

### FIELD OF THE INVENTION

This invention relates to systems and methods for executing jobs based on the availability of computing resources.

### BACKGROUND OF THE INVENTION

Today, large, long-running jobs often require a high level of computing resources such as memory, CPU cycles, and disk storage, to execute. These long-running jobs are generally initiated during periods of low system usage. However, if a system becomes busy while the jobs are running, it can have a negative impact on other critical jobs running on the system at the same time. Many of these longer-running jobs are lower priority and are cancelled when they cause this type of impact. If these jobs are cancelled and restarted, they often have to restart from the beginning and consume the same amount of resources they did prior to the cancellation. In some cases, these jobs may be cancelled several times before they are able to run to completion.

One example of a lower priority job that may be canceled before it runs to completion is a merge sort job that merges several large data sets and sorts the contents into a single new data set. For example, DFSORT is IBM's high-performance sort, merge, copy, analysis, and reporting product for the z/OS operating system. DFSORT is a heavy user of a system's computing resources. Specifically, it uses large amounts of main storage, extended storage (hiperspace, memory object, etc.), and disk storage to complete processing of sort tasks. Currently DFSORT provides a number of installation options to assist users in achieving an appropriate allocation of computing resources. Even with these options in place, there are times when a DFSORT job will start, expecting to have sufficient available computing resources, and yet end prematurely due to an inability to allocate computing resources when they are needed.

In view of the foregoing, what are needed are systems and methods to reduce inefficiencies associated with starting, cancelling, and restarting jobs. Further needed are systems and methods to more efficiently allocate available computing resources to lower priority jobs.

### SUMMARY

The invention has been developed in response to the present state of the art and, in particular, in response to the problems and needs in the art that have not yet been fully solved by currently available systems and methods. Accordingly, the invention has been developed to more efficiently execute jobs, particularly lower priority jobs. The features and advantages of the invention will become more fully apparent from the following description and appended claims, or may be learned by practice of the invention as set forth hereinafter.

Consistent with the foregoing, a method for executing a job is disclosed herein. In one embodiment, such a method includes initiating a job using an initial level of computing resources (e.g., memory resources, CPU resources, and storage resources, etc.). The method suspends the job when available computing resources fall below a first threshold. When suspending the job, the method saves information to enable the job to be resumed at the point where it was suspended. The method then monitors the available computing resources to determine when the available computing resources rise above a second threshold. The second threshold may, in certain embodiments, be the same as the first threshold. The method resumes the job using a reduced level of computing resources when the available computing resources rise above the second threshold.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment in which a system and method in accordance with the invention may be implemented;

FIG. 2 is a process flow diagram showing one embodiment of a method for executing a job;

FIG. 3 is a high-level block diagram showing a job execution module in accordance with the invention;

FIG. 4 is a high-level block diagram showing how one type of job, a DFSORT job, may be used to sort records;

FIG. 5 is a high-level block diagram showing how the DFSORT job may be suspended by systems and methods in accordance with the invention;

FIG. 6 is a high-level block diagram showing how the DFSORT job may be resumed with a reduced level of resources; and

FIG. 7 is a process flow diagram showing one embodiment of a method for executing a DFSORT job.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer-readable program instructions thereon for causing a processor to carry out aspects of the present invention.

The computer-readable storage medium may be a tangible device that can retain and store instructions for use by an instruction execution device. The computer-readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer-readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

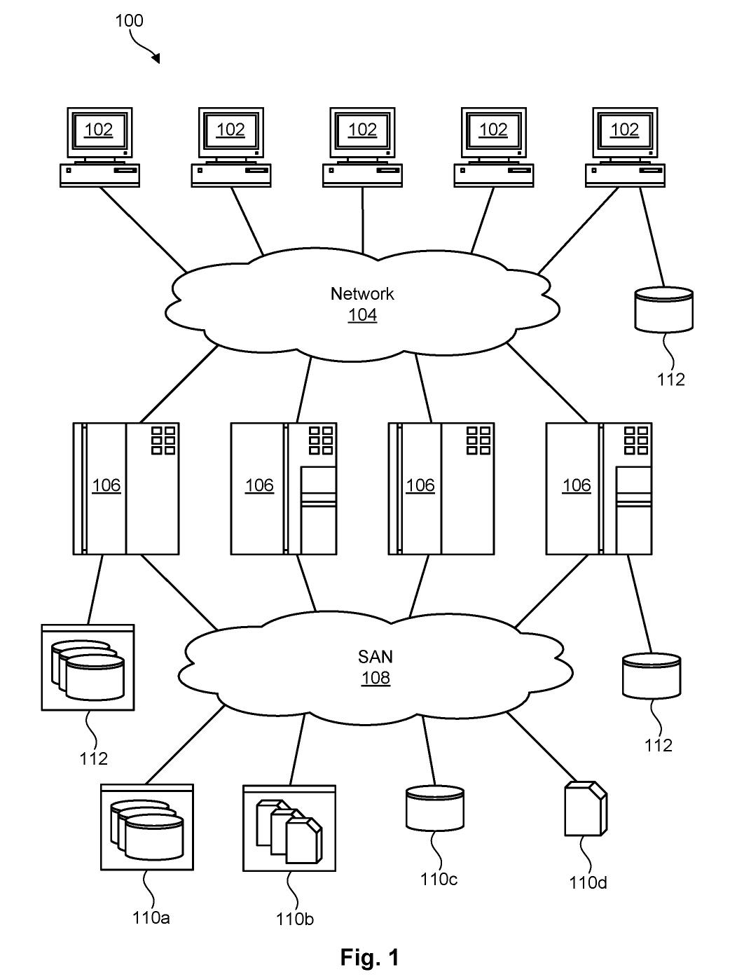

Referring to FIG. 1, one example of a network environment 100 is illustrated. The network environment 100 is presented to show one example of an environment where various embodiments of the invention may operate. The network environment 100 is presented only by way of example and not limitation. Indeed, the systems and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC) or iSCSI.

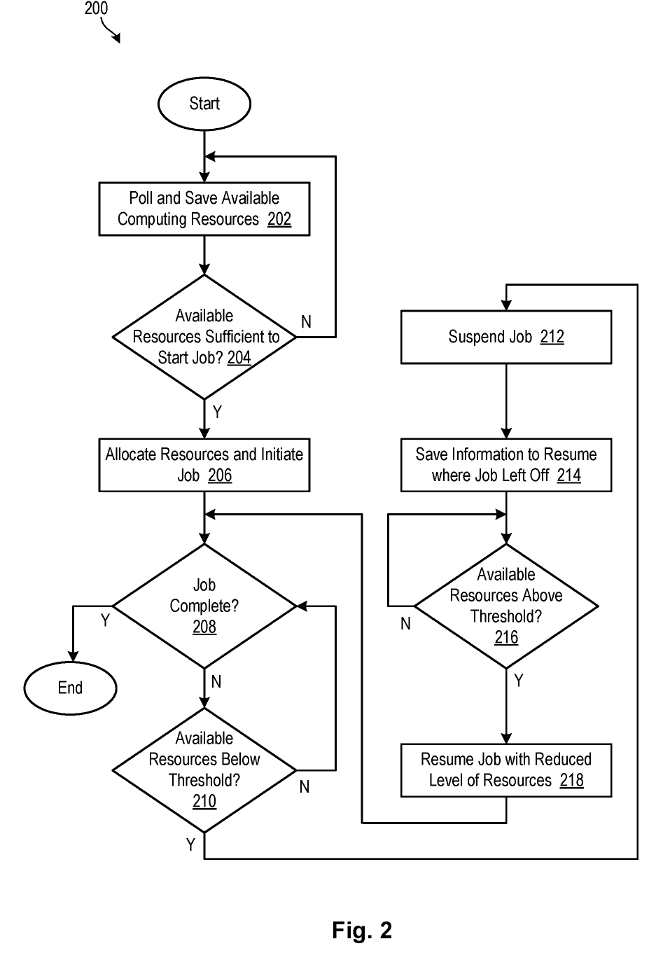

Referring to FIG. 2, as previously mentioned, large, long-running jobs often require a high level of computing resources such as memory, CPU cycles, and disk storage, to execute. These long-running jobs are generally initiated during periods of low system usage. However, if a host system 106 becomes busy while these jobs are running, it can have a negative impact on other critical jobs running on the host system 106 at the same time. Many of these longer-running jobs are lower priority and are cancelled when they cause this type of impact. If these jobs are cancelled and restarted, they often have to start over from the beginning and consume the same amount of resources they did prior to the cancellation. In some cases, these jobs may be cancelled several times before they are able to run to completion.

In view of the foregoing, methods are needed to reduce inefficiencies associated with starting, cancelling, and restarting jobs. Such methods may be used to more efficiently allocate available computing resources to lower priority jobs. One such method 200 is shown in FIG. 2. As will be explained in more detail hereafter, the illustrated method 200 is able to suspend, as opposed to cancel, an active job when computing resources become scarce due to elevated system activity. The job may resume when computing resources once again become available. When resumed, a reduced amount of computing resources may be allocated to the job since the job may already be partially complete. This makes more computing resources available to other jobs running on the host system 106. It also reduces the chance that the job will fail or be suspended again due to a lack of resources. Embodiments of the invention reduce the possibility of job failures due to a lack of computing resources by providing jobs in the system the ability to constantly monitor the availability of computing resources on the host system 106 at any given time, and execute when required computing resources are available.

Embodiments of the invention may enable a job to be completed in sections. Conventionally, a job would need to complete in a single run with available computing resources and within time constraints of a batch window. Systems and methods in accordance with the invention may enable a job to pause and resume, effectively enabling it to be broken into smaller pieces and spread over a longer period of time. This, in turn, reduces the amount of computing resources that are needed at any given time to execute and complete the job.

As shown, a method 200 in accordance with the invention initially polls 202 and saves 202 available computing resources. This information may be useful if a job is initiated but has to be suspended and started again, as will be explained in more detail hereafter. The method 200 then determines 204 whether computing resources are available to start a particular job. If so, the method 200 allocates 206 the computing resources to the job, and initiates 206 the job. The method 200 then monitors 208 the job for completion and monitors 210 whether available computing resources on the host system 106 fall below a selected threshold. The threshold may be, for example, an amount or percentage of available computing resources on the host system 106. If the job has not completed but available computing resources fall below the selected threshold, the method 200 suspends 212 the job and saves 214 information to enable the method 200 to resume the job at the point where it was suspended. This may include saving pointers to input and output data sets to document how far the job had progressed at the time of suspension, saving intermediate files or data sets where the job's work was being performed or stored prior to the suspension, and/or the like.

The method 200 then monitors 216 for when available computing resources rise above a threshold. In certain embodiments, this may be the same threshold used at step 210 or another threshold, such as a reduced threshold. For example, if a job has partially completed and needs fewer computing resources to resume and complete, a lower threshold may be used to resume the job. In other embodiments, the same threshold may be used for suspending and resuming a job.

When, at step 216, the available computing resources rises above the threshold, the method 200 resumes 218 the job at the point where it ceased work at the time of suspension. As discussed above, this resumption may occur with a reduced level of computing resources (compared to the amount saved or recorded at step 202 and/or allocated at step 206), ideally enabling the job to complete even in a resource-constrained environment. In certain embodiments, the reduced level of computing resources may be calculated based on an amount of the job that was completed prior to suspension. If a relatively large portion of the job still needs to be completed, the method 200 may allocate more computing resources to the job. If a relatively small portion of the job needs to be completed, the method 200 may allocate fewer computing resources to the job. In certain embodiments, the amount of a job that was completed prior to the suspension may determine where the threshold at step 216 is established.

After the job is resumed, the method 200 once again monitors 208 for when the job is complete. When the method 200 determines that the job is complete, the method 200 ends. If, at step 210, resources once again drop below a threshold (which may be a modified threshold if the job is executing with a reduced level of resources) before the job completes, the job may be suspended again and the job may once again resume (possibly with an even lower level of computing resources) when the available computing resources rise above a threshold at step 216. This process may repeated until the job is complete. Thus, in certain embodiments, each time a job suspends, the level of computing resources needed to resume the job may ratchet down since more of the job is complete.

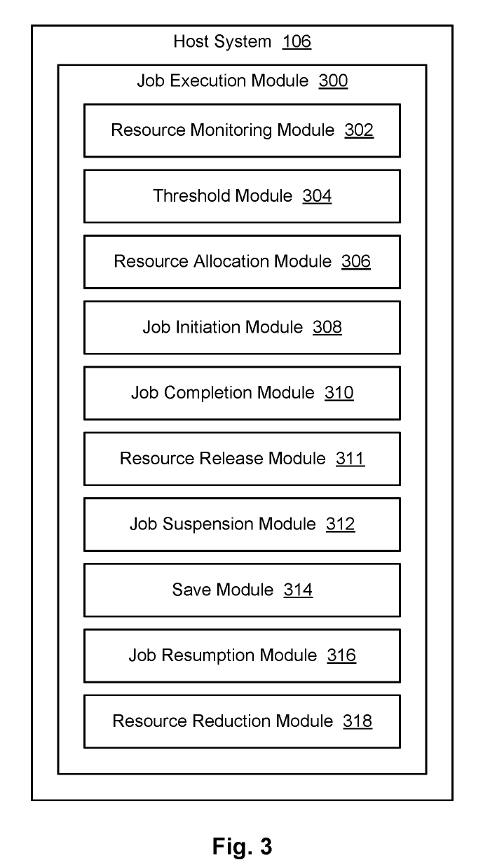

Referring to FIG. 3, in order to implement the method 200 described in association with FIG. 2, a job execution module 300 in accordance with the invention may be implemented on a host system 106. This job execution module 300 may include various sub-modules to provide various features and functions. The job execution module 300 and associated sub-modules may be implemented in hardware, software, firmware, or combinations thereof.

As shown, the job execution module 300 may include one or more of a resource monitoring module 302, threshold module 304, resource allocation module 306, job initiation module 308, job completion module 310, resource release module 311, job suspension module 312, save module 314, job resumption module 316, and resource reduction module 318. The job execution module 300 and associated sub-modules are presented by way of example and not limitation. The job execution module 300 may include more or fewer sub-modules than those illustrated, or the functionality of the sub-modules may be combined or split into additional sub-modules as needed.

The resource monitoring module 302 may be configured to monitor computing resources on a host system 106. The threshold module 304 may be configured to determine when the available computing resources rise above a threshold required to a initiate a job. When the available computing resources rise about the threshold, the resource allocation module 306 may allocate the required computing resources to the job and the job initiation module 308 may initiate the job.

The job completion module 310 may then monitor for completion of the job. When the job completes, the resource release module 311 may release the computing resources allocated to the job. This will enable the computing resources to be allocated to other jobs. During execution of the job, the resource monitoring module 302 may continue to monitor the available computing resources on the host system 106. The threshold module 304 may determine if the available computing resources fall below a designated threshold. If the available computing resources fall below the threshold before the job completes, the job suspension module 312 may suspend the job and the save module 314 may save information indicating the progress of the job at the time of suspension. This information may enable the job to resume where it left off at the time of suspension.

After a job is suspended, the resource monitoring module 302 may continue to monitor the available computing resources. The threshold module 304 may determine if the available computing resources rise above a threshold required to resume the job. As previously mentioned, this threshold may be lower than the threshold used to initiate or suspend the job since the job may require a lesser amount of computing resources when it resumes. If the available computing resources do rise above the threshold, the job resumption module 316 may resume the job at the point where it previously ceased processing. When resuming the job, the resource reduction module 318 may reduce the amount of resources allocated to the job compared to the amount of computing resources that were allocated to the job at the time it was initiated. The amount the computing resources are reduced may depend on how much of the job was complete at the time of suspension.

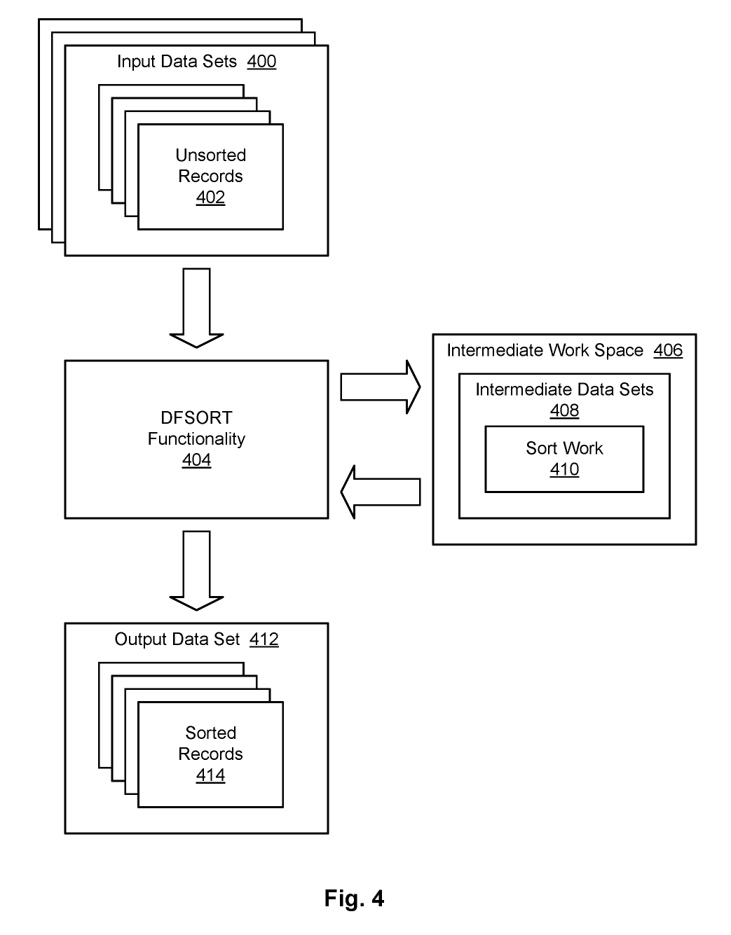

Referring to FIG. 4, as previously mentioned, one example of a lower priority job that may be canceled before it runs to completion is a merge sort job that merges several large input data sets 400 and sorts the contents into a single new output data set 412. DFSORT 404, for example, is IBM's high-performance sort, merge, copy, analysis, and reporting product for the z/OS operating system. The DFSORT job 404 is a heavy user of a system's computing resources. Specifically, it uses large amounts of system storage (e.g., main storage, extended storage (hiperspace, memory object, etc.), and disk storage) to complete processing of sort tasks. Currently the DFSORT job 404 provides a number of installation options to assist users in achieving an appropriate allocation of computing resources. Even with these options in place, there are times when a DFSORT job 404 will start, expecting to have sufficient computing resources available, and yet will end prematurely due to an inability to allocate computing resources when they are needed.

Prior to beginning a DFSORT job 404, the DFSORT job 404 may poll available computing resources and use internal algorithms to determine computing resources that are needed to process the input data sets 400. In certain cases, the DFSORT job 404 may estimate the size of the input data sets 400 based on past runs of the DFSORT job 404 or other statistics and estimate the amount of computing resources that will be required. Unfortunately, this estimate may differ from what is actually required and may cause an under allocation of computing resources. For example, the input data sets 400 may contain more records 402 than what was expected or have an average record length that is different than expected. Conventionally, this can cause a DFSORT job 404 to terminate prematurely before all records 402 are processed. The ability to suspend and resume a DFSORT job 404 in accordance with an amount of available computing resources may address situations where expectations do not match up to reality.

As shown in FIG. 4, when merging unsorted records 402 of several large input data sets 400, the DFSORT job 404 may allocate computing resources such as main storage, extended storage (e.g., hiperspace, memory object, etc.), and disk storage to function as an intermediate work space 406 to perform sort tasks. This intermediate work space 406 may store one or more intermediate data sets 408 to hold sort work 410 (i.e., sorted records) associated with the DFSORT job 404. The DFSORT job 404 generates an output data set 412 containing sorted records 414. Once the DFSORT job 404 is complete, the intermediate work space 406 is released, thereby returning the main storage, extended storage, and/or disk storage and other computing resources used by the DFSORT job 404 to a pool of available computing resources.

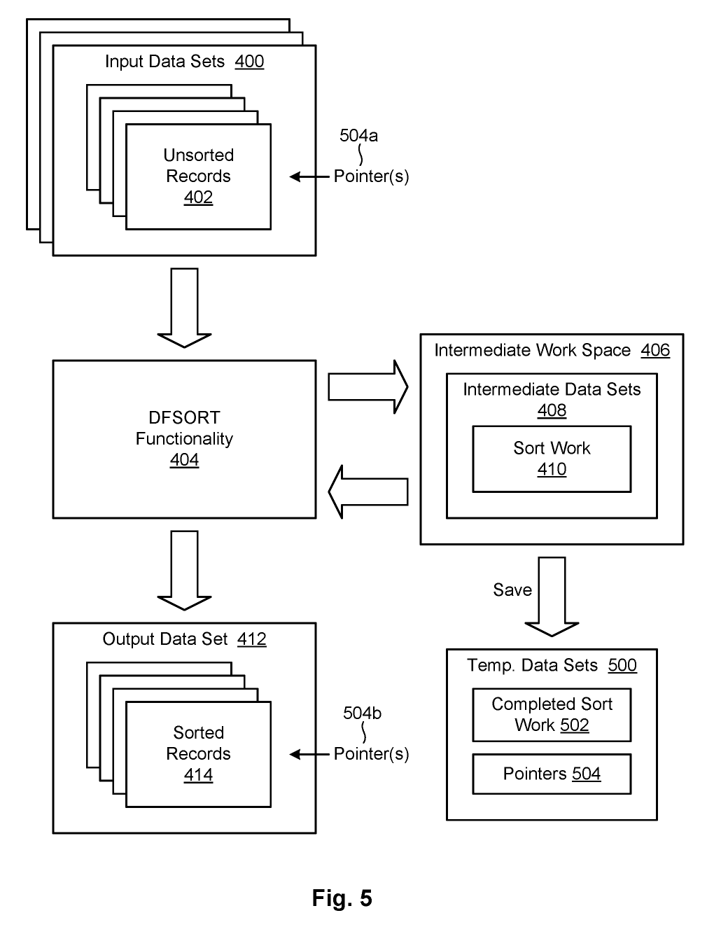

Referring to FIG. 5, when the available computing resources fall below a threshold, the DFSORT job 404 may be suspended and information may be saved in one or more temporary data sets 500 indicating how far the DFSORT job 404 progressed when it was suspended. This information may include pointers 504a, 504b to locations in the input data sets 400 and output data set 412 where the DFSORT job 404 ceased work, as well as completed sort work 502 (e.g., sorted strings) that was completed by the DFSORT job 404. The temporary data sets 500 may be saved to disk or more persistent storage so that system storage (e.g., main storage, extended storage, and/or temporary disk storage) used for the intermediate work space 406 may be released and reallocated to more important or higher priority jobs.

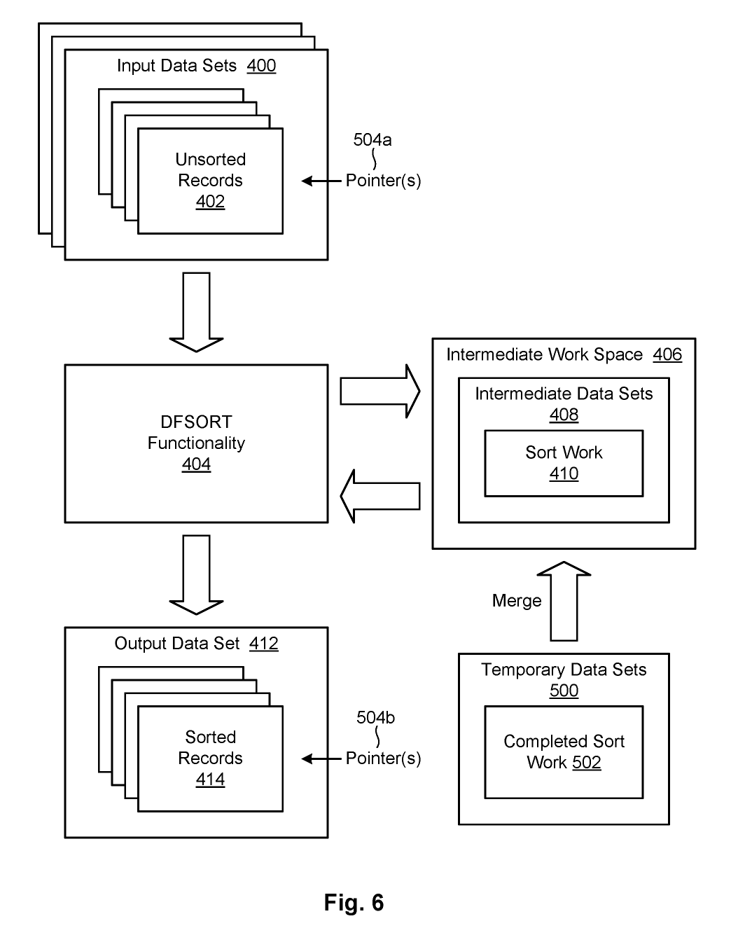

Referring to FIG. 6, a threshold may then be established based on what level of computing resources the DFSORT job 404 needs to complete. When the available computing resources reaches this threshold, the DFSORT job 404 may be resumed. This may include allocating a new intermediate work space 406 and intermediate data sets 408 and continuing sort work 410 where the DFSORT job 404 previously left off (e.g., by analyzing the pointers 504 and other saved information). When the DFSORT job 404 completes the job and associated sort work 410, the sort work 410 may be merged with the completed sort work 502 and output to the output data set 412, which may now contain the complete set of sorted records 414.

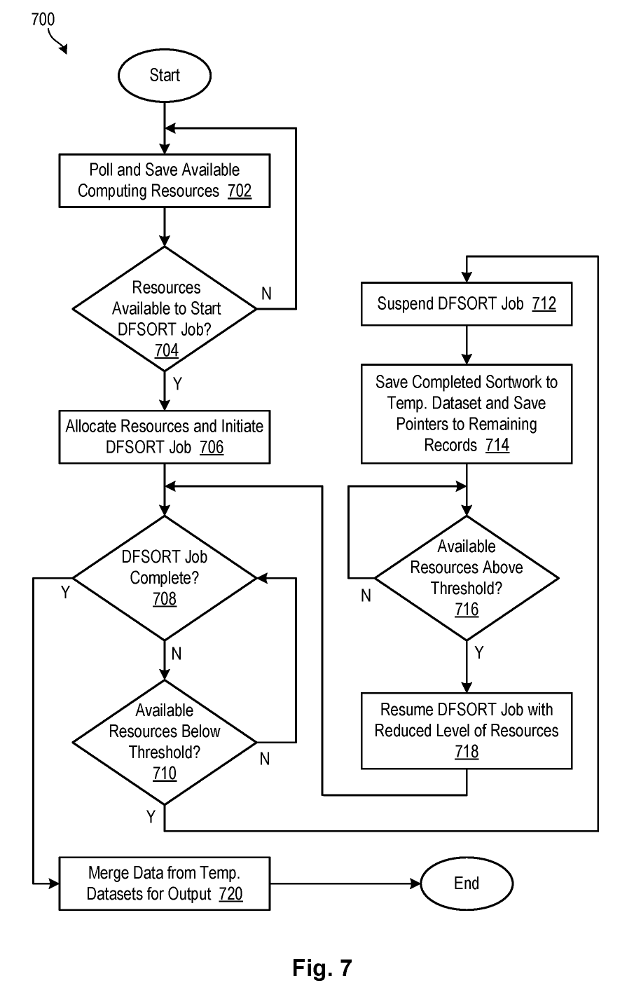

Referring to FIG. 7, one embodiment of a method 700 for executing a DFSORT job 404 is illustrated. As shown, the method 700 initially polls 702 and saves 702 information related to the amount of available computing resources prior to initiating the DFSORT job 404. The method 700 then determines 704 whether sufficient computing resources are available to start the DFSORT job 404. If so, the method 700 allocates 706 the computing resources to the DFSORT job 404 and initiates 706 the job. The method 700 then monitors 708 the DFSORT job 404 for completion and monitors 710 whether available computing resources on the host system 106 fall below a selected threshold. If the DFSORT job 404 has not completed but available computing resources fall below the selected threshold, the method 700 suspends 712 the job and saves 714 information to enable the DFSORT job 404 to resume at the point where it was suspended. This may include saving 714 completed sort work 410 to one or more temporary data sets 500 as well pointers 504 to the input data sets 400 and output data set 412 where the DFSORT job 404 completed its processing.

The method 700 then monitors 716 for when available computing resources rise above a selected threshold. In certain embodiments, this may be the same threshold used at step 710 or another threshold. When, at step 716, the available computing resources rise above the threshold, the method 700 resumes 718 the DFSORT job 404 at the point it terminated processing at the time of suspension. This resumption may occur with a reduced level of computing resources (compared to the amount saved or recorded at step 702 and/or allocated at step 706). In certain embodiments, the reduced level of computing resources may be calculated based on an amount of the DFSORT job 404 that was completed prior to suspension. If a relatively large portion of the DFSORT job 404 still needs to be completed, the method 700 may allocate more computing resources to the DFSORT job 404. If a relatively small portion of the DFSORT job 404 still needs to be completed, the method 700 may allocate fewer computing resources to the DFSORT job 404.

The method 700 then monitors 708 when the sort work 410 associated with the DFSORT job 404 is complete. When the sort work 410 complete, the method 700 merges 720 the sort work 410 with the completed sort work 502 saved at step 714 and the method 700 ends. If, at step 710, resources once again drop below a threshold before the DFSORT job 404 is complete, the DFSORT job 404 may be suspended again and resume once available computing resources rise above a threshold at step 716. This process may be repeated until the DFSORT job 404 is complete.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for executing a job, the method comprising:
initiating a job using an initial level of computing resources;
suspending the job when available computing resources fall below a first threshold;
monitoring the available computing resources to determine when the available computing resources rise above a second threshold; and
resuming the job using a reduced level of computing resources when the available computing resources rise above the second threshold.

2. The method of claim 1, wherein the second threshold is the same as the first threshold.

3. The method of claim 1, wherein suspending the job comprises saving information to enable the job to be resumed at a point where it was suspended.

4. The method of claim 1, further comprising calculating the reduced level of computing resources based on an amount of the job that was completed prior to it being suspended.

5. The method of claim 1, further comprising adjusting a level of resources utilized by the job in accordance with the available computing resources.

6. The method of claim 1, wherein the computing resources include at least one of memory resources, CPU resources, and storage resources.

7. The method of claim 1, wherein the reduced level of computing resources is less than the initial level of computing resources.

8. A computer program product for performing a job, the computer program product comprising a computer-readable storage medium having computer-usable program code embodied therein, the computer-usable program code configured to perform the following when executed by at least one processor:
initiate a job using an initial level of computing resources;
suspend the job when available computing resources fall below a first threshold;
monitor the available computing resources to determine when the available computing resources rise above a second threshold; and
resume the job using a reduced level of computing resources when the available computing resources rise above the second threshold.

9. The computer program product of claim 8, wherein the second threshold is the same as the first threshold.

10. The computer program product of claim 8, wherein suspending the job comprises saving information to enable the job to be resumed at a point where it was suspended.

11. The computer program product of claim 8, wherein the computer-usable program code is further configured to calculate the reduced level of computing resources based on an amount of the job that was completed prior to it being suspended.

12. The computer program product of claim 8, wherein the computer-usable program code is further configured to adjust a level of resources utilized by the job in accordance with the available computing resources.

13. The computer program product of claim 8, wherein the computing resources include at least one of memory resources, CPU resources, and storage resources.

14. The computer program product of claim 8, wherein the reduced level of computing resources is less than the initial level of computing resources.

15. A system for performing a job, the system comprising:
at least one processor;
at least one memory device operably coupled to the at least one processor and storing instructions for execution on the at least one processor, the instructions causing the at least one processor to:
initiate a job using an initial level of computing resources;
suspend the job when available computing resources fall below a first threshold;
monitor the available computing resources to determine when the available computing resources rise above a second threshold; and
resume the job using a reduced level of computing resources when the available computing resources rise above the second threshold.

16. The system of claim 15, wherein the second threshold is the same as the first threshold.

17. The system of claim 15, wherein suspending the job comprises saving information to enable the job to be resumed at a point where it was suspended.

18. The system of claim 15, wherein the instructions further cause the at least one processor to calculate the reduced level of computing resources based on an amount of the job that was completed prior to it being suspended.

19. The system of claim 15, wherein the instructions further cause the at least one processor to adjust a level of resources utilized by the job in accordance with the available computing resources.

20. The system of claim 15, wherein the computing resources include at least one of memory resources, CPU resources, and storage resources.
